(19) United States
(12) Patent Application Publication
(10) Pub. No.: US 2010/0047395 A1
(43) Pub. Date: Feb. 25, 2010

(54) COMPOSITION AND USES THEREOF

(76) Inventors: Erik Zwicker, Orange, CT (US); Barnett S. Press, St. Louis Park, MN (US); Alecia Dotterweich, Minnetonka, MN (US); Vanessa Elizabeth Teter, Orange, CT (US)

Correspondence Address: RYAN, MASON & LEWIS, LLP, 1300 POST ROAD, SUITE 205, FAIRFIELD, CT, 06824, US

(21) Appl. No.: 12/195,128

(22) Filed: Aug. 20, 2008

(51) Int. Cl. A23L 1/302; A23L 1/48; A23P 1/08; A23L 1/01; A23L 1/275; A23L 2/00; A23F 3/00; A23F 5/00; A23C 9/00; A23L 2/02; A23C 9/12

(52) U.S. Cl. 426/72; 426/103; 426/289; 426/296; 426/250; 426/590; 426/597; 426/594; 426/580; 426/599; 426/583

(57) ABSTRACT

A composition comprising one or more starches, an amount of water and an encapsulating agent, wherein the encapsulating agent encapsulates the one or more starches and the amount of the liquid, is provided. Also, techniques for producing a composition are provided. The techniques include combining one or more starches, an amount of a liquid and an encapsulating agent, wherein the encapsulating agent encapsulates the one or more starches and the amount of the liquid, into a composition. Techniques are also provided for using a composition to create a food product.

### FIELD OF THE INVENTION

The present invention generally relates to food science, and, more particularly, to compositions of starches, gums and/or other hydrocolloids.

### BACKGROUND OF THE INVENTION

Tapioca compositions (sometimes referred to as tapioca “pearls,” wherein “pearl” refers to the shape of the composition) are regularly used in a beverage known as bubble tea (also referred to, for example, as bubble milk, boba, boba tea, boba milk tea, pearl milk tea, milk tea, tapioca milk tea, black pearl tea, milk pearl tea, etc.) The compositions (pearls) in such beverages are chewy balls of tapioca, sweet potato, potato, yam and/or cassava plant/root-derived starch that sit at the bottom of the drink and are edible as part of the beverage.

Shops and cafes serve bubble tea to customers on location. However, after preparation, the compositions (pearls) disadvantageously last no more than approximately 6-8 hours. After such time, the exterior of the pearls becomes slimy and undesirably soft, the interior of the pearls becomes hard and loses desirable elasticity and/or chewiness, and the entire pearl can become swollen, taking up most of the space in the beverage container, and/or disintegrate in the beverage.

Consequently, it would be desirable to produce a durable composition that maintains its shape, texture, consistency, firmness, chewiness and color for a prolonged period of time (for example, a duration of time long enough to be in shelf-stable bottle, jar, can, dispenser and/or other container form).

### SUMMARY OF THE INVENTION

Principles of the present invention provide compositions, techniques of production and uses thereof. A composition comprising one or more starches, an amount of liquid and an encapsulating agent, wherein the encapsulating agent encapsulates the one or more starches and the amount of the liquid is provided. An exemplary method for producing a composition, according to one aspect of the invention, can include steps of combining one or more starches, an amount of a liquid and an encapsulating agent, wherein the encapsulating agent encapsulates the one or more starches and the amount of the liquid, into a composition.

An exemplary method for using a composition to create a food product, according to one aspect of the invention, can include adding a composition as described herein to a beverage to create a food product.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating techniques for producing a composition, according to an embodiment of the present invention;

FIG. 2 is a flow diagram illustrating techniques for using a composition to create a food product, according to an embodiment of the present invention;

FIG. 3 is a diagram illustrating compositions, according to an embodiment of the present invention; and

FIG. 4 is a diagram illustrating black milk bubble tea with compositions, according to an embodiment of the present invention.

### DETAILED DESCRIPTION OF PREFERRED EMBODIMENTS

Principles of the present invention include a composition (sometimes referred to as a “pearl” composition, wherein “pearl” refers to the shape of the composition), techniques of production and uses thereof. In an illustrative embodiment of the invention, a composition is produced that maintains its shape, texture, consistency, firmness, chewiness and color for a prolonged period of time (for example, long enough to produce or store in shelf-stable bottle, can, jar, dispenser and/or container form). Advantages to producing a composition with a prolonged duration of quality (that is, a shelf-stable composition) can include, for example, creating a shelf-stable beverage (for example, bubble tea) that incorporates units of the composition in solid form (that is, one is able to create the drink, store the drink, distribute the drink, bottle the drink and sell the drink to customers without the need to prepare the drink within a mere few hours of a customer request).

As described herein, a composition can include multiple components. One component, by way of example, can be a material that acts as a glue, coating agent, encapsulating and/or entrapment agent that can have an encapsulating effect on the composition. Such a component can include, by way of example only, gums, gelatin, egg white, rice flour and/or sodium alginate. Additionally, an alginate (for example, sodium alginate) can be combined with a salt (for example, a divalent or trivalent cation salt (except for magnesium) such as a calcium salt, which can include, for example, calcium chloride, calcium lactate, calcium carbonate, calcium acetate, calcium glycerophosphate, calcium malate, calcium gluconate, calcium sulphate, etc.) to create a water barrier around the composition (that is, forms an alginate gel). One or more embodiments of the invention can also include a coloring agent (for example, a caramel coloring agent). Additionally, a composition as described herein can include a component that acts as an infusing agent (that is, an agent that binds the water to the composition). By way of example only, such a component can include sodium polyphosphate, sodium acid pyrophosphate and polyphosphate.

One or more embodiments of the invention can include a composition with a ratio of water to starch (for example, tapioca starch) of, for example a range of 20-50:50-80. Also, as described herein, such a composition can be cooked in water (for example, boiling water), poured into a mold and cooled (for example, via freezing, cool water rinse, etc.). In one or more embodiments of the invention, a composition can be formed into a pearl-shaped composition via a number of techniques. For example, one can use a syringe, molds (for example, candy molds), a garlic press, a gravity feed through holes of desired size, formation by hand, ambient extrusion, die cast, compression, etc.

Components of a composition can be dry blended by hand or via mechanical apparatus (for example, paddle mixer, double ribbon blender, etc.). One can dry off a portion of the moisture (for example, 4%) to form firm pearls. Additionally, the blended composition can also be heated, for example, via microwaving.

In one or more embodiments of the present invention, a composition can include components in the following percentage ranges:

By way of example and not limitation, a composition can include 71-91% tapioca starch, 1-3% vegetable oil, 0.025-1.0% lecithin, 0.025-3.00% maple flavor and 1.00-8.00% caramel color. One or more embodiments of the invention can include a composition that includes a gum (for example, acacia, agar-agar, cellulose gum, curdlan gum, gellan gum, konjac, hydroxypropyl cellulose, methylcellulose and hydroxypropyl methylcellulose, xanthan, guar, karaya and/or locust bean). Also, an exemplary embodiment of the invention can include a wet blend of sodium alginate (for example, one gram of sodium alginate in 99 milliliters (mL) of water, wherein the sodium alginate wet blend can be heated (for example, to 185 degrees Fahrenheit). Such an alginate solution can be dipped into a salt solution (for example, 5% calcium chloride solution), whereafter beads will form that can be removed from the (calcium) salt solution (for example, after approximately five minutes in the solution).

A wet blend of a composition can also include, for example, coloring. By way of example, one can add two grams of caramel color to the heated alginate solution above, and dip it into calcium chloride solution to produce brown translucent beads. Also, for example, one can prepare 100 mL of a sodium alginate solution (for example, 1% sodium alginate solution) and heat it to a temperate such as, for example, 185 degrees Fahrenheit, and add to it an amount of a dry blend (for example, nine grams of a dry blend such as described above). The combination can be dusted with sodium alginate powder, dipped into sodium alginate solution and soaked in a calcium chloride solution (for example, 5% calcium chloride solution). One can also cool the wet blend to, for example, a temperature of 135 degrees Fahrenheit, and then dip it into a calcium chloride solution, producing beads that may be heated for a period of time (for example, 20 seconds).

Additionally, the heated composition can be coated with a dry blend (such as the dry blend detailed above), and boiled in water (for example, for 30 minutes), let stand for a period of time (for example, 25 minutes) and rinsed with cold water.

Another exemplary embodiment of the invention can include blending 40 grams of a dry blend (such as described herein) into 20 mL of water (a 2:1 dry ingredients to water ratio) to form the composition. One can also use oil and/or lecithin to form the composition. The composition can be coated with an alginate solution (for example, a 1% sodium alginate solution) and dipped into a salt solution (for example, a 5% calcium chloride solution).

Yet another exemplary embodiment of the present invention can include a composition that includes 92.0% tapioca starch, 2.7% canola oil, 0.3% lecithin, 4.0% caramel coloring and 1.0% natural maple flavoring. Such a composition can be used to form, for example, pearls in a two-part dry blend and one-part water combination. Further, one or more embodiments of the invention can additionally include a hydrocolloid (gum) coating solution (for example, a 1% solution). Gums used can include, for example, guar gum, xanthan gum, agar-agar, cellulose gum, gellan gum, konjac, hydroxypropyl cellulose, methylcellulose and/or hydroxypropyl methylcellulose, etc. Such a coated composition can also be dipped, for example, in an alginate solution and/or a (calcium) salt solution.

In one or more embodiments of the invention, a composition can be allowed to air dry (for example, for 48 hours), as well as be reconstituted by boiling (for example, for 30 minutes), left to stand (for example, for 25 minutes) and rinsed in cold water (for example, for five minutes).

Additionally, another exemplary embodiment of the invention can include a composition that includes 92.5% tapioca starch, 2.7% canola oil, 0.3% lecithin, 4.0% caramel coloring, and 0.5% natural maple flavoring. Such a composition can be used to form, for example, pearls in a two-part dry blend and one-part water combination. The composition can also be coated in a 1% hydrocolloid (gum) coating solution (for example, a 1% sodium alginate solution or a 0.5% sodium alginate, 0.5% guar gum solution). The coated composition can be dipped in a calcium chloride solution, rinsed, and allowed to air dry.

The techniques described herein can include the following elements. One can use trays in which to dip and/or soak the composition (or portions therein). The pearls or otherwise shaped compositions can be kept separate during the formation process to preclude them from sticking together. When pouring off water, one can sift the water through a screen. Also, one can air-dry on freezer paper, and drying can be performed so that the bottoms of the compositions are additionally exposed to drying air.

Further, yet another exemplary embodiment of the present invention can include a composition that includes a range of 58.90%-59.40% starch (for example, tapioca starch), a range of 0.00%-0.50% guar gum, 3.65% caramel coloring, 0.45% maple flavoring, and 36.50% water (for example, purified water). The composition can be formed into shapes, cooked, and dipped in 0.75% sodium alginate solution and then 5% calcium chloride solution (for example, for five minutes).

Another exemplary composition can include 58.25% starch, 0.75% guar gum, 4.05% caramel coloring, 0.45% maple flavoring and 36.50% water. Further, the composition can be processed via a number of techniques such as, for example, a full boil and no sodium alginate dip, and a full boil with a 0.6% sodium alginate solution dip and a 2% calcium chloride solution dip (for example, for two minutes).

Further, yet another illustrative embodiment of the invention can include a composition that includes 58.15% tapioca starch, 0.75% guar gum, 4.00% caramel coloring, 0.75% maple flavoring, 0.05% brown sugar and 36.30% water. Also, the composition can be processed by either boiling the composition without dipping it in sodium alginate, or boiling the composition and dipping it in 0.5% sodium alginate solution and dipping it in 2% calcium chloride solution for two minutes.

An exemplary embodiment of the invention can additionally include a composition that includes 56.50% tapioca starch, 37.70% water, 0.75% maple flavoring, 4.00% caramel flavoring, 1.00% guar gum and 0.05% brown sugar. Such a composition can also be dipped into sodium alginate solutions of varying concentration (for example, 0.25%, 0.50%, 0.75% or 1.00% sodium alginate) and/or calcium chloride solutions of varying concentration (for example, 1.00%, 1.50% or 2.00% calcium chloride).

In one or more embodiments of the invention, the formed compositions are cooked (for example, via boiling water) before being coated with sodium alginate and/or calcium chloride. Also, in a preferred embodiment, the composition can be soaked in 1.00% calcium chloride solution for 2-5 minutes.

Also, in one or more illustrative embodiments of the present invention, sodium alginate (for example, in a range of 0.05% and 0.20%) can be blended into the composition mix instead of being used in a dipping solution. A composition can be processed, for example, by boiling followed by being dipped in a 1.00% calcium chloride solution for between 2-5 minutes. In a preferred embodiment of the invention, the composition is dipped in a 1.00% calcium chloride solution for two minutes.

As noted herein, one or more embodiments of the invention use xanthan gum. Additionally, in a composition that uses only xanthan gum, xanthan is preferably used in an amount of 0.15%. Similarly, in a composition that uses only guar gum, guar is preferably used in an amount of 0.25%, and less guar is preferably used when used in combination with other gums. For example, in an exemplary embodiment of the invention, 0.10% sodium alginate (in the composition blend) can be used with 0.15% xanthan (gum). The composition can also include, as an example, a combination of sodium alginate, xanthan and guar.

Further, the composition can also, in one or more embodiments of the invention, include an amount of potato starch and/or modified potato starch. For example, a composition can include modified tapioca starch, potato starch (for example, 2.8% potato starch), sodium alginate (for example, between 0.10% and 0.25% sodium alginate), xanthan and guar in a blend. Such a composition can also be dipped in a salt solution (for example, 1% calcium chloride solution for two minutes). Modified starches can include, for instance, pre-gelatinization, enzyme treatment, hydrolysis, etc. As noted herein, an illustrative embodiment of the invention includes blending sodium alginate into the composition prior to boiling the composition. As described herein, a composition as detailed above can maintain its shape, texture, consistency, firmness, chewiness and color for a prolonged period of time (for example, the composition can be shelf-stable, that is, the composition maintains its quality long enough so that it can be distributed to and/or stored in commercial settings such as cafes, wholesalers, retailers, etc.).

Additionally, one or more embodiments of the invention include lecithin (for example, lecithin at 0.05%) to facilitate the composition's motion through an extruder (or other type of shape-forming mechanism) in a more even and smooth fashion. Also, in an illustrative embodiment of the invention, the dry blend of the composition can include, as measured in percentage makeup of the composition, between 0.05-0.50% sodium alginate, 0.05-0.50% xanthan gum, and 0.05-0.50% guar gum, with a total of the sodium alginate-xanthan-guar combination of 0.50-0.75%.

In yet another exemplary embodiment of the invention, a composition can include (in units of weight) 25-35 grams of tapioca starch (for example 31.86 grams), 1-5 grams of potato starch (for example, 1.62 grams), 0.05-0.75 grams of sodium alginate (for example, 0.15 grams), 0.05-1.0 grams of xanthan gum (for example, 0.12 grams), 0.05-1.0 grams of guar gum (for example, 0.09 grams), and 20-27 grams of water (for example, 22.24 grams). Such an embodiment can also optionally include, for example, 1-8 grams of caramel coloring (for example, 2.36 grams), 0.05-2.0 grams of brown sugar (for example, 0.06 grams), 0.025-1.0 grams of lecithin (for example, 0.06 grams) and 0.25-2.0 grams of maple flavoring (for example, 0.44 grams).

Additionally, as described herein, one or more illustrative embodiments of the invention include a combination of sodium alginate, xanthan and guar gums, as well as a modified tapioca starch. Such a composition is also preferably dipped in a calcium salt solution.

Further, one or more embodiments of the invention include using a composition in a beverage such as, for example, a tea. Techniques for producing such a beverage can include, by way of example, adding 50.00-88.00 grams of composition (for example, 88 individual units of composition, and each weighing 1.00 gram) to a tea (or other liquid beverage, as detailed herein). The 88.00 individual units of composition (for example, 88 pearls) can include, by way of this example, 59.00 grams of composition blend, which can include 31.86 grams of tapioca starch, 1.62 grams of potato starch, 2.36 grams of caramel coloring, 0.06 grams of brown sugar, 0.06 grams of lecithin, 0.15 grams of sodium alginate, 0.12 grams of xanthan gum, 0.09 grams of guar gum, 0.44 grams of maple flavoring and 22.24 grams of water. A finished beverage product can include, for example, approximately 50-100 grams (or an amount desired by an individual) of composition (that is, 50-100 individual units of composition, each weighing approximately 1.00 gram) to 8 fluid ounces of beverage.

Additionally, such an exemplary beverage can be, for example, bottled, jarred or canned as well as shipped or stored for a prolonged period of time (for example, at least three months). Beverages that can be produced using one or more embodiments of the present invention include, by way of example and not limitation, black milk tea, flavored black milk tea, green milk tea, flavored green milk tea, Thai (iced) tea, green tea, black tea, white tea, red tea, herbal tea, coffee drinks, iced coffee, cappuccinos, frappuccinos, mochaccinos, frappes, milkshakes, yogurt drinks, milk-based drinks, soft drinks, fruit smoothies, fruit breezes, fruit juices, as well as a variety of flavored bubble teas (for example, orange, passion fruit, lychee, mango, papaya, kiwi, taro, chocolate, strawberry, raspberry, red bean, mung bean, wheat germ, honeydew, almond, gingerbread, ginger, peanut, peanut butter, butterscotch, sesame, etc).

As such, one or more embodiments of the invention include a flavoring component, wherein the flavor component can include, for example, maple, molasses, orange, passion fruit, lychee, mango, papaya, kiwi-strawberry, taro, chocolate, coffee, etc. Additionally, one or more embodiments of the invention include one or more coloring components such as, for example, caramel coloring, and natural and artificial colors (for example, beta carotene, chlorophyll, FD&C coloring, red, orange, pink, purple, blue, green, etc.). Coloring components can make up, for example, from 0.01-5.0% of the composition.

An illustrative embodiment of the present invention can include a composition that includes (by % of composition) 54.50% tapioca starches, 2.00% potato starch, 4.00% caramel coloring, 0.05% brown sugar, 0.10% lecithin, 0.40% sodium alginate, 0.30% xanthan gum, 0.30% guar gum, 37.60% water and 0.75% maple flavoring.

Additionally, an exemplary embodiment of the invention can include producing a composition as follows. One can blend the components described in the above paragraph until the composition is uniform. The composition can be extruded at an ambient temperature (for example, through die forming small pearls (or balls), wherein the pearls weigh between 0.55 and 0.65 grams). Pressure can be placed on the composition shapes to compress them. Also, one can dust the composition with 2% sodium alginate (that is, 100 grams of composition would be dusted with 2 grams of sodium alginate).

One can add the composition (for example, one part composition) to water (for example, 2-8 parts boiling water, preferably 5 parts boiling water) and boil the composition for 30 minutes (preferably with the lid on). The cooked composition can then be left to stand for 25 minutes (preferably with the lid on). The composition will now be in a viscous solution created by the sodium alginate, and, as such, one can pour off any excess viscous solution and dip the composition into a solution which is 1% sodium alginate and 0.25% caramel coloring. Subsequently, the composition can be drained and placed in a 2% calcium chloride solution (for example, when placing the composition in the solution, one can separate the composition shapes from each other). The composition can soak in the 2% calcium chloride solution for 2-10 minutes, at which point the excess chloride solution can be rinsed off with cool water. Each finished composition shape will weigh about 1.0 gram (according to this illustrative embodiment of the invention).

In one or more embodiments of the invention, using sodium alginate in the amount of up to 0.50% of the composition as well as soaking the composition in at least 1% calcium chloride solution for at least two minutes can help maintain composition color.

As described herein, one or more embodiments of the present invention include a composition, wherein the composition includes one or more starches (for example, tapioca starch, modified tapioca starch, potato starch, modified potato starch, yam starch, modified yam starch, sweet potato starch, modified sweet potato starch, one or more starches derived from a cassava plant or cassava root, corn starch, modified corn starch, wheat flour and/or rice flour), an amount of a liquid (for example, water, tea, etc.) and an encapsulating agent, wherein the encapsulating agent encapsulates the one or more starches and the amount of the liquid.

The encapsulating agent can include, for example, one or more hydrocolloids (that is, a substance that, in combination with a liquid, forms a gel), a gum (for example, acacia, agar-agar, cellulose gum, curdlan gum, gellan gum, konjac, hydroxypropyl cellulose, methylcellulose and hydroxypropyl methylcellulose, xanthan, guar, a combination thereof, karaya, locust bean, carrageenan, etc.), a gelatin, one or more proteins, one or more phosphates, one or more maltodextrins, an egg white, a wax, one or more alginates (for example, sodium alginate, potassium alginate, etc.), one or more alginates combined with one or more salts (for example, divalent or trivalent cation salts (except for magnesium) such as calcium salts, which can include, for example, calcium chloride, calcium lactate, calcium carbonate, calcium acetate, calcium glycerophosphate, calcium malate, calcium gluconate, calcium sulphate, etc.), one or more oils, one or more fats, one or more proteins, one or more carbohydrate systems and/or one or more complexes thereof.

The composition can also include a coloring agent (for example, caramel color, beta carotene, chlorophyll, FDC Yellow 6, red, orange, pink, purple, blue, green, etc.), an infusing agent and/or binder (for example, sodium polyphosphate, soy protein, sodium acid pyrophosphate and/or polyphosphate), lecithin, mono-glyceride, di-glyceride, a spice, an herbal supplement and/or a flavoring agent (for example, maple, molasses, orange, passion fruit, lychee, mango, papaya, strawberry, raspberry, chocolate, coffee, red bean, mung bean, taro, etc.).

FIG. 1 is a flow diagram illustrating techniques for producing a composition, according to an embodiment of the present invention. Step 102 includes combining one or more starches (for example, tapioca starch, modified tapioca starch, potato starch, modified potato starch, yam starch, modified yam starch, sweet potato starch, modified 5 sweet potato starch, one or more starches derived from the cassava plant or cassava root, corn starch, modified corn starch, wheat flour and/or rice flour), an amount of a liquid (for example, water, tea, etc.) and an encapsulating agent, wherein the encapsulating agent encapsulates the one or more starches and the amount of the liquid, into a composition. In one or more embodiments of the invention, as depicted by FIG. 1, the composition can include components as described above.

Also, in one or more embodiments of the present invention, the starches can be in a range of 30-90% of the composition. The encapsulating agent can be in a range of 0.10-10.0% of the composition. Also, the amount of liquid (for example, water) can include a range of 10-70% of the composition.

One or more embodiments of the invention include cooking the composition (for example, boiling the composition in water). The techniques depicted in FIG. 1 can also include placing the composition into a calcium chloride solution (for example, a 1-5% calcium chloride solution) for an amount of time (for example, for between 1-30 minutes). One or more embodiments of the invention can also include dipping the composition in a sodium alginate solution (for example, for between 1-30 minutes), as well as rinsing the composition with water.

The techniques depicted in FIG. 1 can also include molding the composition into a desired shape (for example, a pearl, a square, a star, etc.). Molding the composition can include manually molding the composition and/or using a mechanical device to mold the composition. Additionally, one or more embodiments of the invention can include combining a coloring agent (for example, caramel color, beta carotene, chlorophyll, FDC Yellow 6, red, orange, pink, purple, blue, green, etc.), an infusing agent and/or binder (for example, sodium polyphosphate, soy protein, sodium acid pyrophosphate polyphosphate, etc.), lecithin, mono-glyceride, di-glyceride, a spice, a vitamin, a mineral, an herbal supplement and/or a flavoring agent (for example, maple, molasses, orange, passion fruit, lychee, mango, papaya, strawberry, raspberry, chocolate, coffee, red bean, mung bean, taro, etc.). A composition such as depicted in FIG. 1 can result in a solid that is chewable and stable in a liquid environment for a period of time.

The techniques depicted in FIG. 1 can include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more dry alginates (a dry alginate can be, for example, combined into a dry blend of the composition and/or dusted or applied onto the dry blend of the composition) and one or more dry salts (a dry salt can be, for example, combined into a dry blend of the composition and/or dusted or applied onto the dry blend of the composition) into a composition.

Additionally, the techniques depicted in FIG. 1 can include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more alginate solutions (for example, a solution in a range of 1-10% alginate can be sprayed and/or showered onto the composition and/or the composition can be dipped, placed or soaked in an alginate solution bath) and one or more salt solutions (for example, a solution in a range of 1-10% salt solution can be sprayed and/or showered onto the composition and/or the composition can be dipped, placed or soaked in an alginate solution bath) into a composition.

Also, the techniques depicted in FIG. 1 can include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more dry alginates and one or more salt solutions into a composition. Further, the techniques depicted in FIG. 1 can include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more dry alginates, one or more alginate solutions and one or more salt solutions into a composition.

The techniques depicted in FIG. 1 can also include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more dry salts and one or more alginate solutions into a composition. Further, the techniques depicted in FIG. 1 can additionally include an encapsulating agent that includes one or more alginates and one or more salts (for example, calcium salts), and wherein combining the one or more starches, the amount of the liquid and the encapsulating agent into a composition includes combining the one or more starches, the amount of the liquid, one or more dry alginates, one or more dry salts, one or more alginate solutions and one or more salt solutions into a composition.

The techniques depicted in FIG. 1 can also include an encapsulating agent that includes one or more alginates and one or more salts, and wherein combining the one or more starches, the amount of the liquid and the encapsulating agent into a composition includes combining the one or more starches, the amount of the liquid, one or more dry alginates, one or more dry salts and one or more salt solutions into a composition. Additionally, one or more embodiments of the invention can include an encapsulating agent that includes one or more alginates and one or more salts, and wherein combining the one or more starches, the amount of the liquid and the encapsulating agent into a composition includes combining the one or more starches, the amount of the liquid, one or more alginate solutions, one or more dry salts and one or more salt solutions into a composition.

Further, the techniques depicted in FIG. 1 can include an encapsulating agent that includes one or more alginates and one or more salts, and wherein combining the one or more starches, the amount of the liquid and the encapsulating agent into a composition includes combining the one or more starches, the amount of the liquid, one or more dry alginates, one or more alginate solutions and one or more dry salts into a composition.

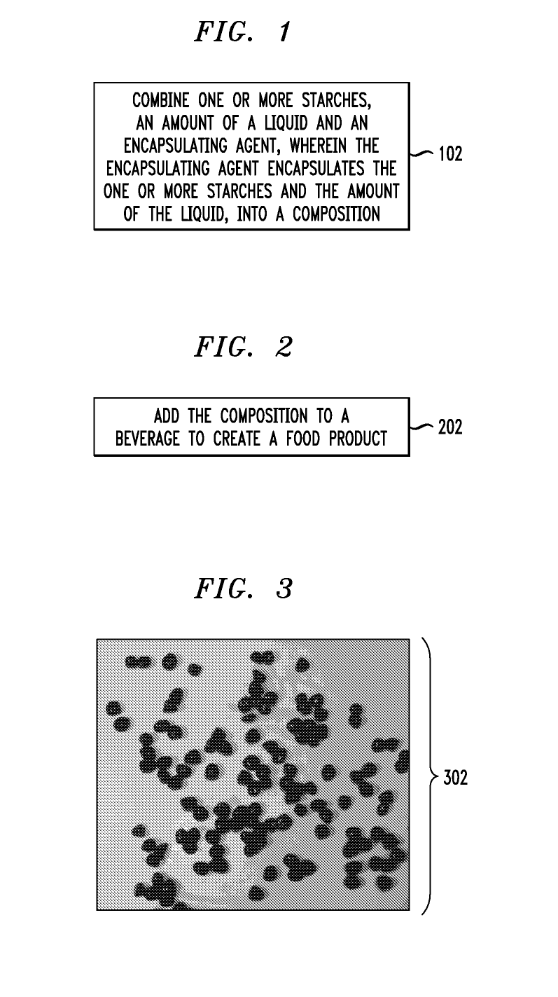

FIG. 2 is a flow diagram illustrating techniques for using a composition to create a food product, according to an embodiment of the present invention. Step 202 includes adding the composition to a beverage to create a food product (for example, a food, beverage, or combination thereof). The beverage can include, for example, tea, coffee drinks, smoothies, soft drinks, fruit drinks, or any other variety of beverage. The food product can include, for example, a shelf-stable food product (that is, the composition maintains its quality long enough so that it can be stored and/or distributed to commercial settings such as cafes, wholesalers, retailers, etc.).

Also, the food product can include, by way of example and not limitation, black milk tea, flavored black tea, green milk tea, flavored green milk tea, Thai (iced) tea, green tea, black tea, white tea, red tea, herbal tea, coffee drinks, iced coffee, cappuccinos, frappuccinos, mochaccinos, frappes, milkshakes, yogurt drinks, milk-based drinks, soft drinks, fruit drinks, fruit smoothies, fruit breezes, fruit juices, as well as a variety of flavored bubble teas. One could also use a composition described herein as, for example, a chewable solid in a liquid, semi-solid, or solid environment. Additionally, one could add nutrients to the composition (for example, herbal supplements, minerals, vitamins, etc.) as well as incorporate the composition into a gel-like tofu or gelatin.

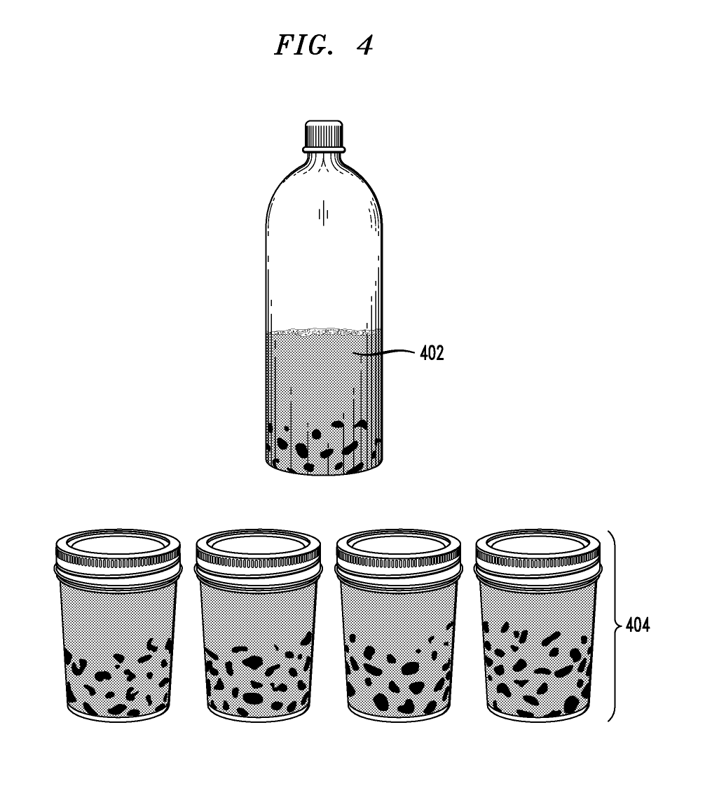

FIG. 3 is a diagram illustrating compositions 302, according to an embodiment of the present invention. Further, FIG. 4 is a diagram illustrating black milk bubble tea with compositions, according to an embodiment of the present invention. By way of illustration, FIG. 4 depicts black milk bubble tea produced using the techniques described herein in a bottle 402 as well as in jars 404.

As noted herein, the limited and disadvantageous existing compositions must be cooked and/or prepared on location for a customer because such compositions (pearls) disadvantageously last no more than approximately 6-8 hours, and therefore would be unstable and not useable in a food product if they were fully prepared prior to being sent to the commercial establishment. At least one embodiment of the invention provides one or more beneficial effects, such as, for example, producing a composition that maintains its shape, texture, consistency, firmness, chewiness and color for a prolonged period of time (for example, the composition is shelf-stable, that is, the composition maintains its quality, after cooking it, preparing it and/or adding it to a beverage, for a period of time long enough so that it can be stored and/or distributed to commercial settings such as cafes, wholesalers, retailers, etc., without requiring that the composition be cooked and prepared for customers on location).

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A composition, wherein the composition comprises:
one or more starches;
an amount of a liquid; and
an encapsulating agent, wherein the encapsulating agent encapsulates the one or more starches and the amount of the liquid.

2. The composition of claim 1, wherein the encapsulating agent comprises at least one of one or more hydrocolloids, a gum, a gelatin, one or more proteins, one or more phosphates, one or more maltodextrins, an egg white, a wax, one or more alginates, one or more alginates combined with one or more salts, one or more oils, one or more fats, one or more proteins, one or more carbohydrate systems and one or more complexes thereof.

3. The composition of claim 1, further comprising at least one of a coloring agent, an infusing agent, lecithin, mono-glyceride, di-glyceride, a flavoring agent, a spice, a vitamin, a mineral and an herbal supplement.

4. The composition of claim 1, wherein the one or more starches comprise at least one of tapioca starch, modified tapioca starch, potato starch, modified potato starch, yam starch, modified yam starch, sweet potato starch, modified sweet potato starch, one or more starches derived from a cassava plant, one or more starches derived from a cassava root, corn starch, modified corn starch, wheat flour and rice flour.

5. The composition of claim 1, wherein the one or more starches comprise one or more starches in a range of 30-90% of the composition.

6. The composition of claim 1, wherein the encapsulating agent comprises an encapsulating agent in a range of 0.10-10.0% of the composition.

7. The composition of claim 1, wherein the amount of a liquid comprises a range of 10-70% of the composition.

8. A method for producing a composition, the method comprising combining one or more starches, an amount of a liquid and an encapsulating agent, wherein the encapsulating agent encapsulates the one or more starches and the amount of the liquid, into a composition.

9. The method of claim 8, further comprising cooking the composition.

10. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates and one or more dry salts into a composition.

11. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more alginate solutions and one or more salt solutions into a composition.

12. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates and one or more salt solutions into a composition.

13. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates, one or more alginate solutions and one or more salt solutions into a composition.

14. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry salts and one or more alginate solutions into a composition.

15. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates, one or more dry salts, one or more alginate solutions and one or more salt solutions into a composition.

16. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates, one or more dry salts and one or more salt solutions into a composition.

17. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more alginate solutions, one or more dry salts and one or more salt solutions into a composition.

18. The method of claim 8, wherein the encapsulating agent comprises one or more alginates and one or more salts, and wherein combining the one or more starches, the amount of the liquid and the encapsulating agent into a composition comprises combining the one or more starches, the amount of the liquid, one or more dry alginates, one or more alginate solutions and one or more dry salts into a composition.

19. The method of claim 8, further comprising molding the composition into a desired shape.

20. The method of claim 19, wherein molding the composition comprises at least one of manually molding the composition and using a mechanical device to mold the composition.

21. The method of claim 8, further comprising combining at least one of a coloring agent, an infusing agent, lecithin, a flavoring agent, mono-glyceride, di-glyceride, a spice, a vitamin, a mineral and an herbal supplement.

22. The method of claim 8, wherein the one or more starches comprise at least one of tapioca starch, modified tapioca starch, potato starch, modified potato starch, yam starch, modified yam starch, sweet potato starch, modified sweet potato starch, one or more starches derived from a cassava plant, one or more starches derived from a cassava root, corn starch, modified corn starch, wheat flour and rice flour.

23. The method of claim 8, wherein the encapsulating agent comprises at least one of one or more hydrocolloids, a gum, a gelatin, one or more proteins, one or more phosphates, one or more maltodextrins, an egg white, a wax, one or more alginates, one or more alginates combined with one or more salts, one or more oils, one or more fats, one or more proteins, one or more carbohydrate systems and one or more complexes thereof.

24. The method of claim 8, wherein the one or more starches comprise one or more starches in a range of 30-90% of the composition.

25. The method of claim 8, wherein the encapsulating agent comprises an encapsulating agent in a range of 0.10-10.0% of the composition.

26. The method of claim 8, wherein the amount of a liquid comprises a range of 10-70% of the composition.

27. A method for using a composition of claim 1 to create a food product, the method comprising adding the composition of claim 1 to a beverage to create a food product.

28. The method of claim 27, wherein the beverage comprises at least one of one or more teas, one or more coffee drinks, one or more milk-based drinks, one or more yogurt-based drinks, one or more smoothies, one or more soft drinks, one or more fruit juices and one or more fruit drinks.

29. The method of claim 27, wherein the food product comprises a shelf-stable food product.

30. The method of claim 27, wherein the food product comprises at least one of black milk tea, one or more flavored black milk teas, green milk tea, one or more flavored green milk teas, one or more flavored milk teas, Thai tea, Thai iced tea, green tea, white tea, black tea, red tea, herbal tea, one or more coffee drinks, iced coffee, cappuccino, a frappuccino, a mochaccino, one or more frappes, one or more milkshakes, one or more soft drinks, one or more fruit drinks, one or more fruit juices, one or more smoothies, one or more fruit breezes, one or more yogurt drinks, one or more milk-based drinks and one or more flavored bubble teas.
